(19) United States
(12) Patent Application Publication
(10) Pub. No.: US 2011/0157659 A1
(43) Pub. Date: Jun. 30, 2011

(54) INFORMATION PROCESSING APPARATUS, METHOD FOR CONTROLLING THE INFORMATION PROCESSING APPARATUS, AND STORAGE MEDIUM

(75) Inventor: Naomi Zenju, Tokyo (JP)

(73) Assignee: CANON KABUSHIKI KAISHA, Tokyo (JP)

(21) Appl. No.: 12/973,789

(22) Filed: Dec. 20, 2010

(30) Foreign Application Priority Data
Dec. 25, 2009 (JP) 2009-295440

(51) Int. Cl. H04N 1/04

(52) U.S. Cl. 358/474

(57) ABSTRACT

An information processing apparatus configured to extract information about a processing target field from a processing instruction sheet, read a ticket to which an image that has been encoded into a format that enables the extracted information and a content of processing to be executed for the processing target field is added, and execute processing for extracting the information added to the ticket, includes a recognition unit configured to recognize a processing target field and a content of processing to be executed for the field from the ticket read and a determination unit configured to determine a content of processing to be executed for the processing target field according to a combination of a plurality of processing contents recognized for the processing target field recognized. The information processing apparatus executes processing having the content determined by the determination unit on the processing target document.

### BACKGROUND OF THE INVENTION

1. Field of the Invention

The present invention relates to an information processing apparatus and an information processing apparatus control method configured to extract additional information that has been added to a document and execute processing according to a result of the extraction, and to a storage medium that stores a program of the control method.

2. Description of the Related Art

A conventional method reads an image of a document, such as a business form or an answer sheet by using a scanner to extract symbols or numeric characters included in the document. By using the conventional method like this, it is enabled to easily utilize data extracted from a document including a number of sheets for processing such as accumulation.

Japanese Patent Application Laid-Open No. 08-307660 discusses the following method. In this conventional method, a user enters processing instruction information, which includes a processing target field and a content of the processing in a processing target document by hand. By reading the processing instruction information by using a scanner, the conventional method identifies the processing target field and the processing content. Furthermore, the conventional method generates a processing instruction sheet based on the identified processing target field and the processing content. In addition, in the conventional method discussed in Japanese Patent Application Laid-Open No. 08-307660, a user operates an operation unit to determine what processing is to be executed on the processing target field described in a document based on the information extracted from the processing instruction sheet.

However, the conventional method discussed in Japanese Patent Application Laid-Open No. 08-307660 discusses a method for describing a processing content in a processing target document but does not discuss a method for generating a processing instruction sheet separately from the processing target document. Furthermore, the method discussed in Japanese Patent Application Laid-Open No. 08-307660 does not discuss a method enabling a user to give an instruction for executing various processing by generating a plurality of processing instruction sheets based on contents included in a combination of the plurality of processing instruction sheets.

### SUMMARY OF THE INVENTION

The present invention is directed to an information processing apparatus capable of determining a new processing content based on a combination of a plurality of processings or on only selected specific processing according to information extracted from a plurality of processing instruction sheets read by a scanner.

According to an aspect of the present invention, an information processing apparatus configured to extract information about a processing target field from a processing instruction sheet, which is a document including a description of a processing target field of a processing target document, read a ticket to which an image that has been encoded into a format that enables recognition of a content of processing to be executed for the processing target field is added, and execute processing extracted from the information added to the ticket, includes a reading unit configured to read a plurality of tickets, a recognition unit configured to recognize a processing target field and a content of processing to be executed for the field from the ticket read by the reading unit, and a determination unit configured to determine a content of processing to be executed for the processing target field according to a combination of a plurality of processing contents recognized by the recognition unit for the processing target field recognized by the recognition unit, wherein processing having the content determined by the determination unit is executed on the processing target document.

According to an aspect of the present invention, it is enabled to combine a plurality of processings and to select specific processing only according to information extracted from a plurality of processing instruction sheets read by a scanner.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an exemplary configuration of an image processing apparatus, which is an example of an information processing apparatus according to an exemplary embodiment of the present invention.

FIGS. 2A through 2D illustrate an example of a processing target document.

FIG. 3 (FIGS. 3A and 3B) is a flow chart illustrating an exemplary flow of processing for generating a scan ticket.

FIGS. 4A through 4C illustrate an example of a scan ticket generated based on the processing instruction sheet illustrated in FIGS. 2B through 2D.

FIG. 5 is a flow chart illustrating an exemplary flow of processing for checking a document by using a scan ticket.

FIG. 6 illustrates an example of a screen displayed on an operation unit.

FIG. 7 illustrates an example of a screen displayed on the operation unit.

FIG. 8 illustrates an example of a screen displayed on the operation unit.

FIG. 9 is a flow chart illustrating an exemplary flow of processing for combining scan tickets.

FIG. 10 is a flow chart illustrating an exemplary flow of processing for combining processing items.

### DESCRIPTION OF THE EMBODIMENTS

Various exemplary embodiments, features, and aspects of the invention will be included in detail below with reference to the drawings.

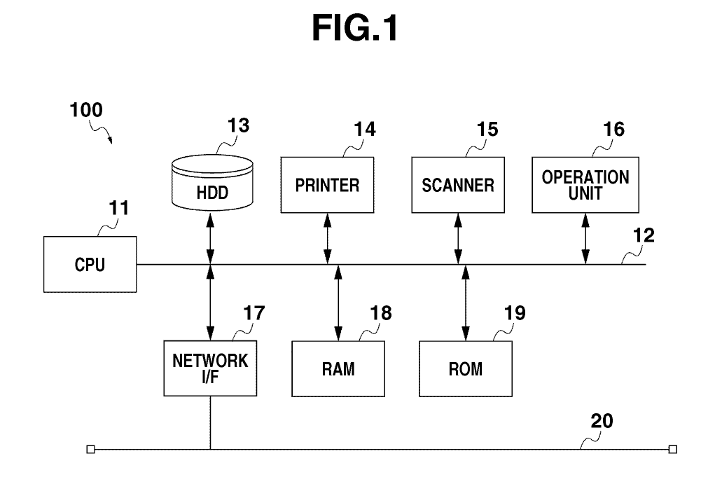

A first exemplary embodiment of the present invention will now be described below. FIG. 1 illustrates an exemplary configuration of an image processing apparatus, which is an example of an information processing apparatus according to an exemplary embodiment of the present invention. Referring to FIG. 1, an image processing apparatus 100 according to a first exemplary embodiment is a multifunction peripheral (MFP) having various functions, such as a copy function and a scanner function. However, the functions can be implemented by a plurality of apparatuses operating in cooperation with one another.

In the example illustrated in FIG. 1, a central processing unit (CPU) 11 controls an operation of the entire image processing apparatus 100 by loading and executing a program from a read-only memory (ROM) 19 onto a random access memory (RAM) 18. In addition, the CPU 11 communicates with each component of the image processing apparatus 100 via the bus 12. An operation unit 16 includes a plurality of keys used by a user to give an instruction. Furthermore, the operation unit 16 includes a display unit that displays various information to be notified to the user.

A scanner (i.e., a reading apparatus) 15 reads an image of a document set by the user on a document positioning plate as a color image. In addition, the scanner 15 stores electronic data (image data) acquired by the reading onto a hard disk drive (HDD) 13 and the RAM 18. The HDD 13 is a hard disk drive including a hard disk. The HDD 13 stores various input information. Furthermore, the scanner 15 includes a document feeder and is capable of serially feeding a plurality of documents from the document feeder onto the document positioning plate to read an image thereof.

A printer (printing apparatus) 14 prints an image, which is generated based on input image data, on a recording paper (sheet). A network I/F 17 is an interface for connecting the image processing apparatus 100 to a network 20. Furthermore, the network I/F 17 controls reception of data from an external network apparatus and transmission of data to an external network apparatus.

In the present exemplary embodiment, image data to be used for the processing described below is input via the scanner 15. However, the same effect as that of the processing described below can be implemented by inputting image data of a document transmitted from an external apparatus via the network I/F 17.

In addition, the same effect as that of the processing described below can be implemented by using a personal computer (PC) to which a scanner and a printer are connected. In this case, a part of or the entire program of a method according to the present exemplary embodiment can be provided to the PC via the network or via a storage medium, such as a compact disc-read only memory (CD-ROM), which stores the program.

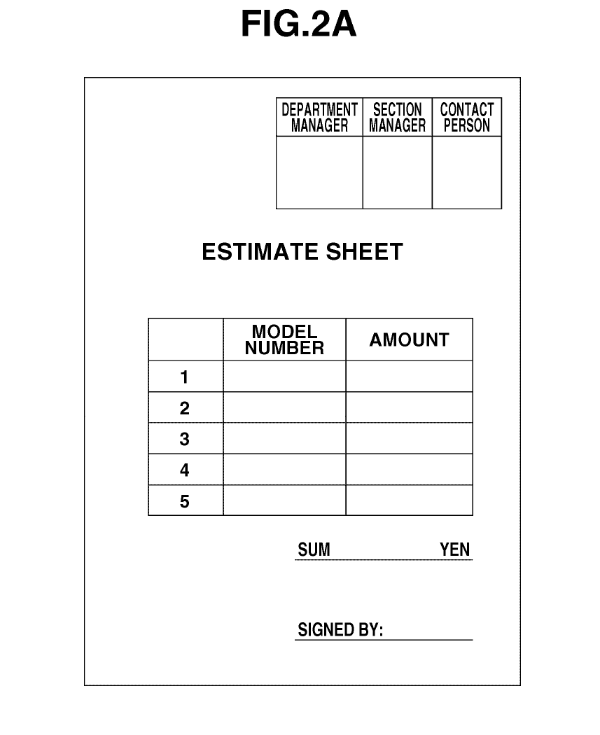

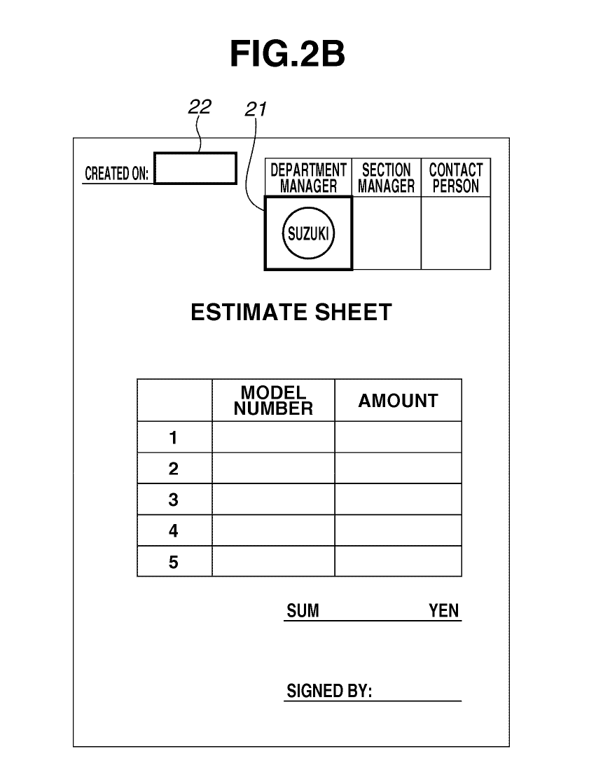

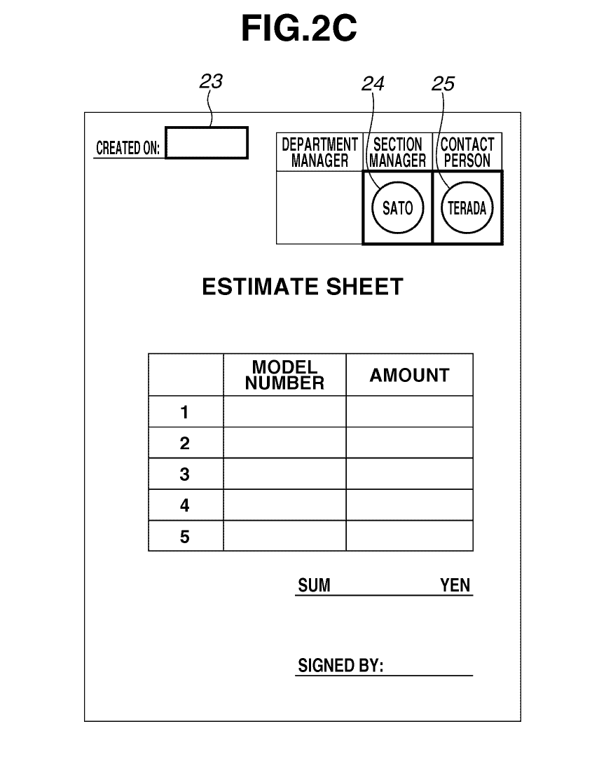

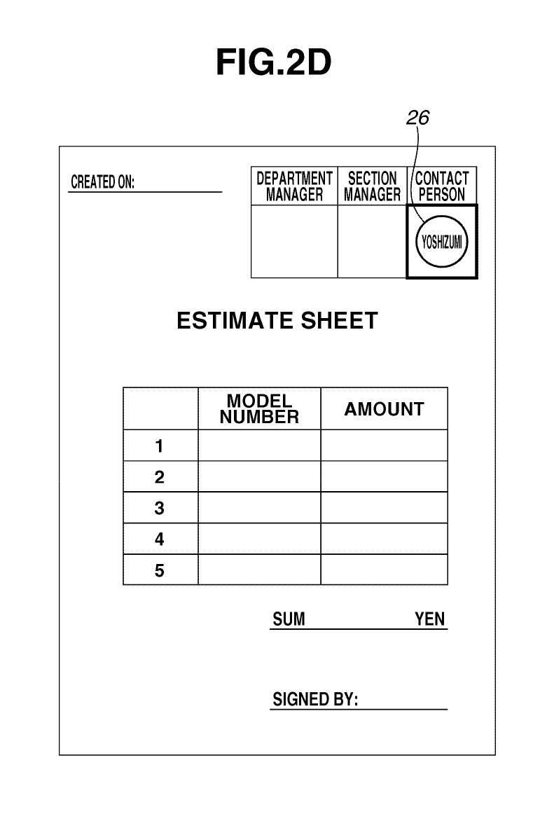

Now, an example of a document used in the present exemplary embodiment will be described in detail below with reference to FIGS. 2A through 2D. FIG. 2A illustrates an example of a form of a document used in the present exemplary embodiment.

The document illustrated in FIG. 2A is an estimate sheet (a form document) including no description by the user (i.e., an estimate sheet before processing instruction information, which will be described in detail below, has not been added thereto yet). The estimate sheet includes fields for various fields, such as a date of creation field, a model number field, an amount field, a sum field, a signature field, and a field for sealing by a department manager, a section manager, and a contact person. Before finally publishing the estimate sheet, the user enters information (content) to each such field.

The present exemplary embodiment checks whether a specific field designated by the user, of the above-described fields of the estimate sheet, includes information added by the user while a specific other field, of the above-described fields of the estimate sheet, includes no information. FIGS. 2B through 2D illustrate an example of a check target document after the user has added information to an arbitrary check target field of the check target document, of the item fields included in the document illustrated in FIG. 2A, by using a color pen. The document illustrated in each of FIGS. 2B through 2D is used as a processing instruction sheet.

In the present exemplary embodiment, a processing instruction sheet is created by the user who checks the generated estimate sheet (the check target document) by writing processing instruction information, which will be described in detail below, onto a sheet having the same format as the format of the check target estimate sheet. To paraphrase this, the estimate sheet illustrated in FIG. 2A including processing instruction information is used as the processing instruction sheet. In the present exemplary embodiment, in order to designate a field to be processed (a processing target field), the user surrounds the processing target field as a closed field having a rectangular shape, by using a color pen by hand.

Now, processing instruction information (the additional information) to be written in the estimate sheet (the document) will be described in detail below. In the present exemplary embodiment, it is supposed, in the example illustrated in FIG. 2B, that the user has added information to a field 21 by using a red pen, and that information has been added to a field 22 by using a blue pen. In addition, in the example illustrated in FIG. 2C, it is supposed that information has been added to a field 23 by using a green pen and that information has been added to fields 24 and 25 by using a red pen.

Furthermore, in the example illustrated in FIG. 2D, it is supposed that information has been added to a field 26 by using a red pen. However, a pen of any other color can be used. In addition, the number of colors of pens used in the present exemplary embodiment is not limited to three. In other words, the number of colors of the pens can be decreased or increased according to the contents to be checked. Furthermore, a tool other than a pen capable of marking the field with a color can be used instead of the above-described pen.

In addition, the user previously associates information about the color and the content of processing included in processing instruction information to be used and registers the associated information and processing content to the RAM 18 by using the operation unit 16. More specifically, the user previously associates the color of red used for surrounding the field with processing for checking whether the field includes a seal within a frame of the field.

Furthermore, the user associates the color of blue used for surrounding the field with processing for checking whether a text string is included within a frame of the field. In addition, the user previously associates the color of green used for surrounding the field with processing for checking whether the field has been left blank. The user previously registers the above-described relationship between the color and the corresponding processing content to the RAM 18. In the present exemplary embodiment, it is also supposed that image data of the seal provided within the field has been previously registered to the HDD 13.

The present exemplary embodiment analyzes image data of the seal provided in the corresponding field and compares image data of the seal that has been previously registered to the HDD 13. In the present exemplary embodiment, a seal corresponding to the previously registered data is provided on the sheet. However, the present exemplary embodiment is not limited to this. More specifically, a symbol or the like can be entered in the field can be used instead of a seal if the symbol or the like can be effectively subjected to comparison with previously registered data. On the other hand, if no image data of a seal has been previously registered to the HDD 13, an image of a seal for the field can be newly registered.

The CPU 11 determines a color component (the hue, for example) of each color registered in the above-described manner, and stores the corresponding processing content to the RAM 18. The color can be registered by using the scanner 15 by reading the information written on the sheet instead of using the operation unit 16.

In addition, the color can be previously registered to the image processing apparatus 100 by a manufacturer of the image processing apparatus 100, instead of requiring the user to register the color. If the color and the corresponding processing content are previously registered to the image processing apparatus 100, the user adds processing instruction information to the document according to the registered color and the corresponding processing content.

As described above, the present exemplary embodiment registers the color component of the processing instruction information to be used and the corresponding processing content, and generates a processing instruction sheet according to the registered processing content.

In addition, the present exemplary embodiment extracts the processing instruction information, and recognizes the processing content according to a result of the extraction. Accordingly, the image processing apparatus 100 checks whether the check target document includes information in its specific field, whether a specific field of the document has been left blank, and whether a specific field of the document includes a seal.

In the present exemplary embodiment, the processing instruction information added to the processing instruction sheet as illustrated in FIGS. 2B through 2D is extracted. Furthermore, the processing target document is processed according to the extracted processing instruction information. More specifically, for the processing instruction sheet illustrated in FIG. 2B, if it is determined that a text string is included in the field 22 and that a registered seal is included in the field 21, then it is determined that the document has been normally created.

For the processing instruction sheet illustrated in FIG. 2C, if no information is included in the field 23 (i.e., if the field 23 has been left blank) and if a registered seal has been included in each of the fields 24 and 25, then the processing instruction sheet illustrated in FIG. 2C is determined to have been normally created. For the processing instruction sheet illustrated in FIG. 2D, if a registered seal has been provided in the field 26, then the processing instruction sheet illustrated in FIG. 2D is determined to have been normally created.

Now, scan ticket generation processing, which is processing for checking the content of a description included in a document according to the processing instruction sheet (FIGS. 2B through 2D), will be described in detail below. In the present exemplary embodiment, a “scan ticket” refers to a ticket having a format that enables the image processing apparatus 100 to recognize the content of the instruction illustrated in FIGS. 2B through 2D and a method for checking a check target document. QR codes can be used as the above-described format of the ticket.

A scan ticket includes the content of the instruction recognized and extracted from the document illustrated in FIGS. 2B through 2D and positional information about a field to which the content of the instruction is to be applied. In checking the check target document, at first, the scanner 15 reads the scan ticket. Then, the CPU 11 recognizes the content of the instructed processing. The check target document is checked according to the recognized processing content.

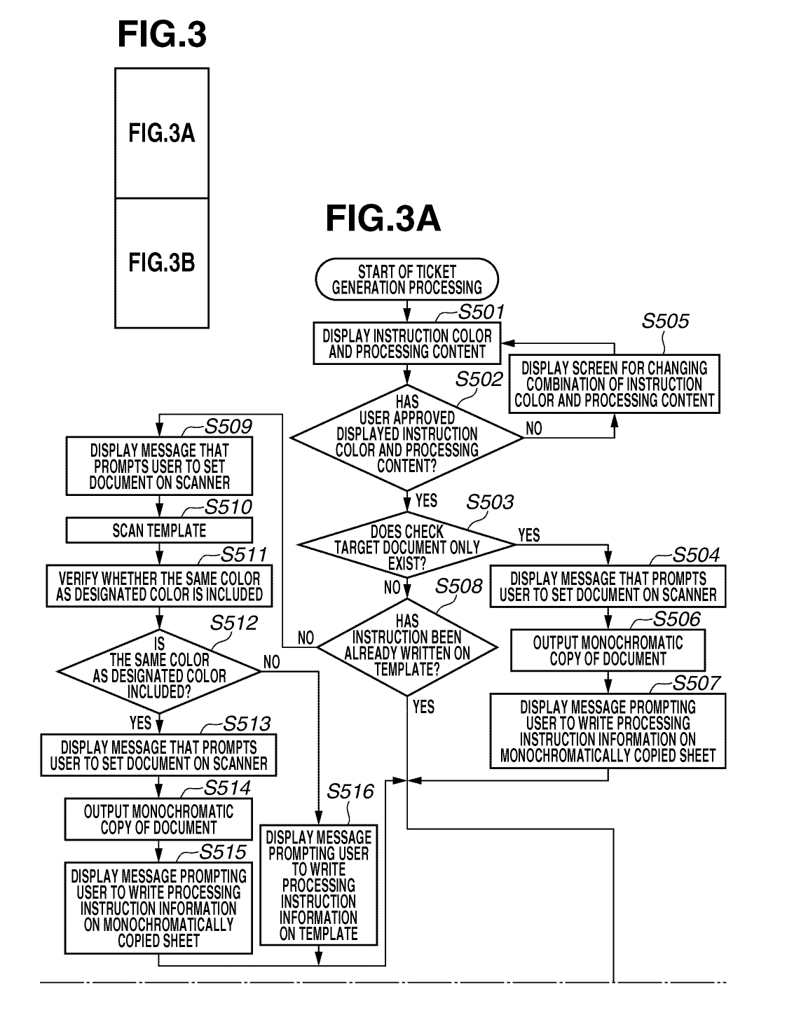

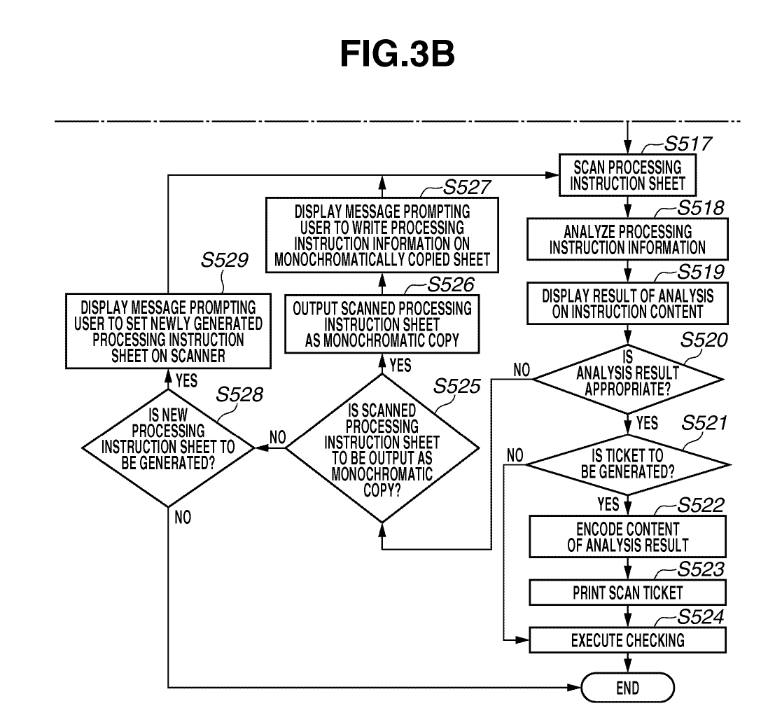

FIG. 3 (FIGS. 3A and 3B) is a flow chart illustrating an example of scan ticket generation processing according to the present exemplary embodiment. The processing in the flow chart of FIG. 3 is implemented by the CPU 11 by loading and executing a program from the ROM 19 on the RAM 18.

When the user gives an instruction for generating a scan ticket by operating the operation unit 16, the flow illustrated in FIG. 3 starts. Referring to FIG. 3, in step S501, the CPU 11 displays, on the operation unit 16, a combination of an instruction color included in processing instruction information that has been registered to the RAM 18 (hereinafter the instruction color included in the processing instruction information is simply referred to as a “instruction color”) and a content of the designated processing.

More specifically, the CPU 11 displays a message, such as “if a description is included in the field surrounded with a red mark, the document is determined normal”. In step S502, the CPU 11 displays a message for prompting the user to determine and input whether the instruction color and the processing content displayed in step S501 are appropriate.

If it is determined and input by the user via the operation unit 16 that the instruction color and the processing content displayed in step S501 are not appropriate (No in step S502), then the processing proceeds to step S505. In step S505, the CPU 11 displays a message indicating that the combination of the instruction color and the processing content is to be changed on the operation unit 16.

More specifically, in step S505, the CPU 11 can display a message that prompts the user to determine and input a color to be changed, and can display a new color instead of the instruction color. Alternatively, the user can designate an arbitrary color by operating the operation unit 16. Further, alternatively, the CPU 11 can merely change the combination of the color and the processing content instead of displaying a new color. The CPU 11 cannot give an instruction of different processing contents by the same color. Accordingly, the CPU 11 executes control so that one color corresponds to one processing content only.

After executing the processing in step S505 for changing either the instruction color or the processing content or both the instruction color and the processing content, the processing proceeds to step S501 and executes the above-described display. In this case, in step S501, it is presented to the user to verify that the changing processing has been executed in step S505.

On the other hand, in response to the inquiry in step S502, if it is determined and input by the user via the operation unit 16 that the displayed instruction color and the processing content are appropriate (Yes in step S502), then the processing proceeds to step S503. In this case, the CPU 11 determines the instruction color and the corresponding processing content included in the processing instruction information to be used. Furthermore, the CPU 11 registers the determined information to the RAM 18.

As described above, by executing the determination in step S502, the user is allowed to visually verify the content of the document (the color included in the document), and causes the CPU 11 to determine that the color component of the instruction color and the color component of the color included in the document are different from each other even if they are determined to be similar to each other. Accordingly, the present exemplary embodiment can prevent an error in extracting processing instruction information.

If it is determined that the color component included in the document is similar to the color component of the instruction color (Yes in step S502), then the CPU 11 can monochromatically copy the document as will be described below. More specifically, in this case, the CPU 11 displays, on the operation unit 16, a message that prompts the user to set the document. Then, if it is determined that the document has been set, the document is monochromatically copied.

If the user executes an instruction by using the instruction color mark provided on the monochromatic copy, the present exemplary embodiment can also prevent an error in extracting processing instruction information when the processing instruction information has been added by using a color pen. In addition, by executing determination according to a result of verification by the user, the present exemplary embodiment can effectively reduce the number of times of reading a document by using the scanner.

If it is determined that the instruction color and the processing content are appropriate (Yes in step S502), then the CPU 11 identifies and extracts the color component used in the processing instruction information, and stores the extracted color component to the RAM 18.

In step S503, the CPU 11 displays a message, on the operation unit 16, which prompts the user to enter whether the user has the check target document only. More specifically, the message displayed in step S503 prompts the user to enter whether the document that can be used as the template in generating a processing instruction sheet exists.

In other words, the display in step S503 is executed so that if the user has the check target document only, the user can generate a document in which the processing instruction information is to be written based on the check target document. In the present exemplary embodiment, a “template” refers to a form of a document, which is different from a check target document and to which the user can add processing instruction information.

If it is determined and input via the operation unit 16 that the user has the check target document only (i.e., that no document that can be used as the template exists) (Yes in step S503), then the processing proceeds to step S504. Instep S504, the CPU 11 displays a message on the operation unit 16 that prompts the user to set the check target document on the scanner 15.

More specifically, in this case, a guidance message “Please set one sheet of check target document. After setting the sheet, please press the “OK” button.” is displayed. In addition, the OK button is displayed, which is used for recognizing that the document has been set. In the present exemplary embodiment, the CPU 11 recognizes that the document has been set when the OK button is pressed.

However, it can be automatically recognized that the document has been set on the scanner 15 by using a photo interrupter provided below the document positioning plate or a document sensor included in the document feeder.

If it is determined that the OK button has been pressed in step S504, then the processing proceeds to step S506. In step S506, the CPU 11 controls the scanner 15 to read an image of the check target document. In addition, the CPU 11 converts the image data input by the scanner 15 into monochromatic image data. Furthermore, the CPU 11 outputs the image data to the printer 14 to print and output the image data on a recording paper as a monochromatic copy.

In step S506, the read document is converted into monochromatic image data and printed by using the printer 14. However, the present exemplary embodiment is not limited to this. More specifically, the document can be printed by using the printer 14 after converting the color of the read document image into a different other color that does not include the instruction color.

More specifically, the document can be output after converting the color of a red character of the read document image into a different other color, such as blue. Further alternatively, it is also useful if a color conversion target color is previously registered to the RAM 18, and the target color is converted if the same color as the registered target color exists in the read document image.

In step S507, the CPU 11 displays a message, on the operation unit 16, which prompts the user to write the processing instruction information on the recording paper output by the printer 14 in step S506. On the other hand, if it is determined and input by the user that the user has a template document (No in step S503), then the processing proceeds to step S508. In step S508, the CPU 11 displays a message, on the operation unit 16, which prompts the user to determine and input whether the processing instruction information has been already described in the template.

If it is determined and input by the user via the operation unit 16 that no processing instruction information has been described in the template (No in step S508), then the processing proceeds to step S509. In step S509, the CPU 11 displays a message, on the operation unit 16, which prompts the user to set the template on the scanner 15.

More specifically, in step S509, a guidance message, such as “Please set the template on the scanner. After setting the template, please press the OK button”, and the OK button are displayed. In the present exemplary embodiment, the CPU 11 recognizes that the document has been set when the OK button is pressed.

However, it can be automatically recognized that the document has been set on the scanner 15 by using a photo interrupter provided below the document positioning plate or a document sensor included in the document feeder.

If it is determined that the OK button has been pressed in step S509, then the processing proceeds to step S510. In step S510, the CPU 11 executes control for reading an image of the template document by using the scanner 15. In step S511, the CPU 11 executes analysis and recognition processing for determining whether the image data acquired in the above-described manner includes a color component of the same color as the instruction color.

In the color component analysis and recognition processing, in determining whether, for example, the color of red is included, the CPU 11 executes processing for extracting the hue of the color of red. For the color component analysis and recognition, various publicly known methods can be used. Furthermore, a parameter other than the hue can be used. Moreover, a combination of different other parameters can be used.

In step S512, the CPU 11 determines whether the same color as the instruction color that has been registered to the RAM 18 is included in the color that has been subjected to the analysis and recognition in step S511. For the determination as to whether the instruction color and the color that has been subjected to the analysis and recognition in step S511, the colors can be determined to be the same if they completely match each other or if they match within a specific difference range.

More specifically, if red (R), green (G), and blue (B) (RGB) values are presented in 256 levels, it is also useful if the RGB value of the color that has been analyzed and recognized in step S511 is compared with the RGB value of the instruction color. In this case, it can be determined that the analysis and recognition target color is the same as the instruction color if the difference between the RGB values is within the range of 20 levels, greater or smaller. A method different from that described above can be used in determining whether the analysis and recognition target color and the instruction color are the same.

If it is determined that the same color as the instruction color that has been registered to the RAM 18 is included in the image of the template (Yes in step S512), then the processing proceeds to step S513. In step S513, the CPU 11 displays a message, on the operation unit 16, which prompts the user to set the template on the scanner 15. More specifically, in step S513, a message, such as “Please set the template on the scanner. After setting the template, please press the OK button.” and the OK button are displayed.

In the present exemplary embodiment, the CPU 11 recognizes that the document has been set when the OK button is pressed. However, it can be automatically recognized that the document has been set on the scanner 15 by using a photo interrupter provided below the document positioning plate or a document sensor included in the document feeder.

If it is determined that the OK button has been pressed in step S513, then the processing proceeds to step S514. In step S514, the CPU 11 controls the scanner 15 to read an image of the check target document. In addition, the CPU 11 converts the image data input by the scanner 15 into monochromatic image data. Furthermore, the CPU 11 outputs the image data to the printer 14 to print and output the image data on a recording paper as a monochromatic copy.

In step S514, the read document is converted into monochromatic image data and printed by using the printer 14. However, the present exemplary embodiment is not limited to this. In other words, alternatively, the document can be printed by using various other methods as described above similar to the processing in step S506.

In step S515, the CPU 11 displays a message, on the operation unit 16, which prompts the user to write the processing instruction information on the recording paper output by the printer 14 in step S514.

On the other hand, if it is determined that the same color as the instruction color that has been registered to the RAM 18 is not included in the image of the template (No in step S512), then the processing proceeds to step S516. In step S516, the CPU 11 displays a message, on the operation unit 16, which prompts the user to write the processing instruction information in the template document.

In step S508, the CPU 11 displays a message, on the operation unit 16, which prompts the user to determine and input whether the processing instruction information has been already described in the template (FIG. 2B). If it is determined and input by the user via the operation unit 16 that the processing instruction information has already been described in the template (Yes in step S508), then the processing proceeds to step S517.

In step S517, the CPU 11 controls the scanner 15 to read an image of the document (template) including the processing instruction information. In step S517, the scanner 15 reads the image of the document by executing the same processing as that described above, which is executed in outputting the document image as a monochromatic copy. More specifically, the CPU 11 executes control for displaying a message that prompts the user to set the document including the processing instruction information on the operation unit 16.

When the user sets the document and presses the OK button after that, the CPU 11 controls the scanner 15 to read an image of the document. However, in this case, the image data acquired by reading the image of the document by using the scanner 15 is not to be converted into monochromatic image data, and is stored on the RAM 18 as it is.

In step S518, the CPU 11 analyzes and recognizes the processing instruction information based on the image data input by the scanner 15. More specifically, in step S518, the CPU 11 analyzes in which field of the document the instruction color determined in step S502 exists. Furthermore, for each color, the CPU 11 recognizes the color of the field to identify the location of the analysis and recognition target field.

Based on the location identified in step S518, a processing target field of what size exists in which field of the document can be determined. The location can be identified and expressed by coordinates. In addition, the CPU 11 associates the location identified in step S518 with the processing content determined in step S502. Furthermore, the CPU 11 stores the associated identified location and the processing content on the RAM 18.

In step S519, the CPU 11 displays a result of the analysis and the recognition executed in step S518 on the operation unit 16. More specifically, in step S519, the CPU 11 displays, on the operation unit 16, the coordinates of the field corresponding to the identified processing instruction information and the content of the processing to be executed on the field. Alternatively, the following configuration can be employed. That is, the CPU 11 executes control for displaying a thumbnail image of the read document image. In this case, by displaying the thumbnail image corresponding to the read document image, it is enabled to identify the location of the field in which the processing instruction information is described, and what the content of the corresponding processing is.

In step S520, the CPU 11 displays, on the operation unit 16, a message that prompts the user to verify whether the content of the display displayed in step S519 is appropriate. If it is determined and input by the user via the operation unit 16 that the content of the display displayed in step S519 is not appropriate (No in step S520), then the processing proceeds to step S525. In step S525 (FIG. 3B), the CPU 11 displays, on the operation unit 16, a message that prompts the user to determine and input whether to output the image of the template read by the scanner 15 in step S517 by using the printer 14 as a monochromatic copy.

If the user inputs a positive instruction via the operation unit 16 (Yes in step S525), then the processing proceeds to step S526 (FIG. 3B). In step S526, the CPU 11 converts the image of the document read by using the scanner 15 in step S517 into monochromatic image data and outputs the image data by using the printer 14 as a monochromatic copy.

To paraphrase this, if the processing instruction information has not been normally extracted, the CPU 11 executes control for monochromatically copying the processing instruction sheet to which the processing instruction information has been added. Furthermore, by using the above-described copy, the CPU 11 adds the processing instruction information to the template again. In step S526, the CPU 11 generates a monochromatic copy of the document and prints the copy by using the printer 14. However, the present invention is not limited to this. In other words, alternatively, the document can be printed by using various other methods as described above similar to the processing in step S506.

In step S527, the CPU 11 displays a message, on the operation unit 16, which prompts the user to write the processing instruction information on the recording paper output by the printer 14 in step S526.

On the other hand, if it is determined and input by the user via the operation unit 16 that the document is not to be output as a monochromatic copy (No in step S525), then the processing proceeds to step S528 (FIG. 3B). In step S528, the CPU 11 displays, on the operation unit 16, a message that prompts the user to determine and input whether to generate a new processing instruction sheet.

If it is instructed by the user via the operation unit 16 to generate a new processing instruction sheet (Yes in step S528), then the processing proceeds to step S529. In step S529, the CPU 11 displays, on the operation unit 16, a message that prompts the user to set the newly generated processing instruction sheet on the scanner.

On the other hand, in response to the message in step S528, if it is instructed by the user via the operation unit 16 not to generate a new processing instruction sheet (No in step S528), then the processing ends.

After executing the display in step S527 or S529, if the user has set the document and pressed the OK button by operating the operation unit 16 to instruct reading of the document, the CPU 11 executes the processing in step S517 again.

If it is input by the user via the operation unit 16 that the analysis result is appropriate (Yes in step S520), then the CPU 11 stores the content of the analysis on the RAM 18 as a result of extraction of the processing instruction information.

In step S521, the CPU 11 displays a message, on the operation unit 16, which prompts the user to determine and input whether to generate a scan ticket. If it is instructed by the user to generate a scan ticket via the operation unit 16 (Yes in step S521), then the processing proceeds to step S522. In step S522, the CPU 11 encodes the content of the analysis.

More specifically, in encoding the content of the analysis, the CPU 11 encodes the result of the analysis displayed in step S519 by using a two-dimensional code, such as the QR code. The content to be encoded includes the field that has been instructed to be processed and the content of the processing to be executed for the field.

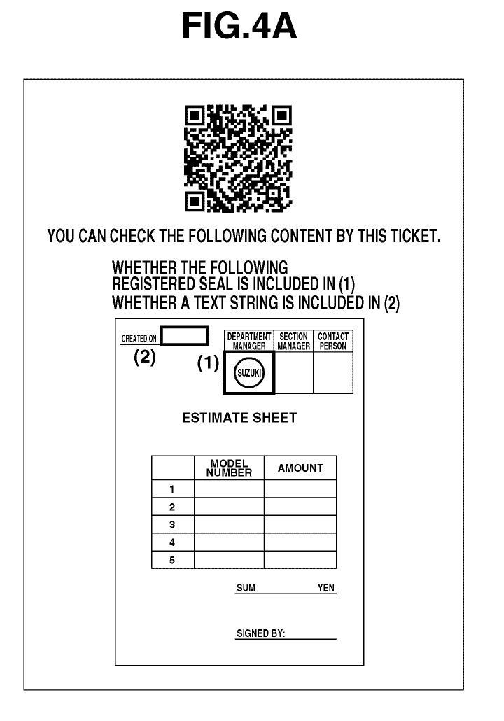

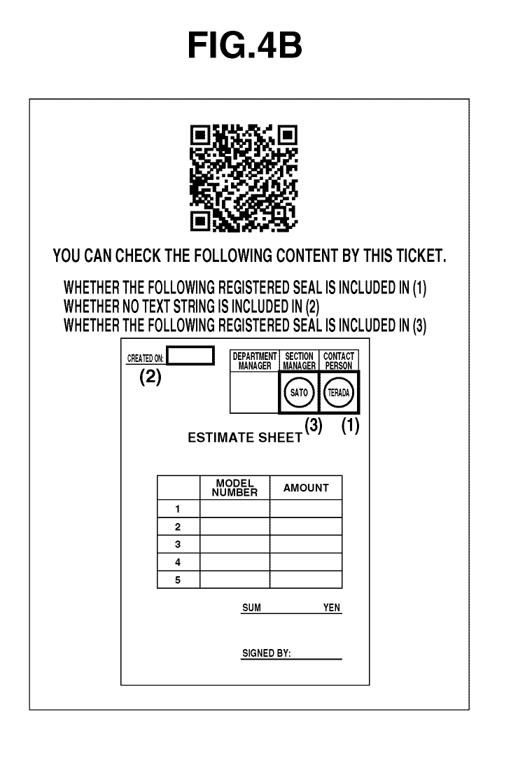

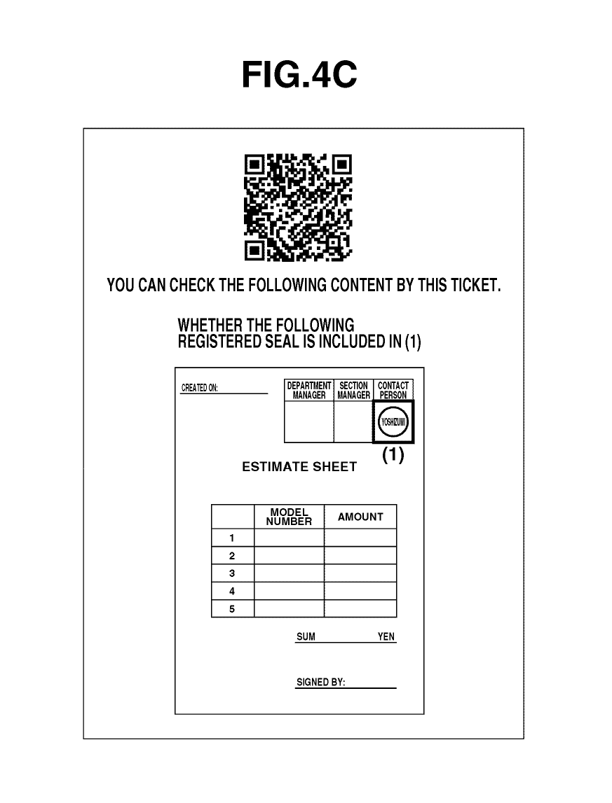

In the present exemplary embodiment, a two-dimensional code is used in encoding the analysis result. However, the present exemplary embodiment is not limited to this. More specifically, a different other method that can be appropriately used by the image processing apparatus 100 for the analysis and the recognition, can be used for the encoding. In step S523, the CPU 11 executes control for printing and outputting the coded data generated in step S522 on the recording paper by using the printer 14 as an image. FIGS. 4A through 4C each illustrate an example of a scan ticket generated by the above-described method according to the processing instruction sheet illustrated in FIGS. 2B through 2D.

By using the scan ticket printed in the above-described manner, the processing target document (the check target document) can be checked. However, because it is indicated that the processing instruction sheet having been read by using the scanner 15 in step S517 has been appropriately recognized if it is determined and input by the user in step S520 that the analysis result is appropriate, the processing instruction sheet can be used as the scan ticket without executing the processing in steps S521 through 523. In this case, the CPU 11 can recognize the processing content from the processing instruction sheet in checking the document.

If the user has input a negative instruction for the message displayed in step S521 via the operation unit 16 (No in step S521), then the CPU 11 displays an identification (ID) for identifying the content of the analysis registered in step S520 on the operation unit 16. The ID is displayed to identify the analysis content, and to read and utilize the same from the ROM 19, in checking the check target document.

Alternatively, the user can designate a desired ID via the operation unit 16 instead of displaying the ID under control of the CPU 11. The ID determined in the above-described manner and the analysis content are associated with each other, and the mutually associated ID and the analysis content are stored on the RAM 18. Then, the processing proceeds to step S524.

In step S524, the CPU 11 checks the check target document according to the processing instruction information and the corresponding processing content recognized in the above-described manner. The details of the processing will be described below.

By executing the above-described processing, the present exemplary embodiment can print the document, whose color component has been converted into a color component different from the color component of the instruction color and to which the user adds the processing instruction information. Accordingly, the present exemplary embodiment enables the processing instruction information added to the processing instruction sheet to be appropriately and normally recognized. In other words, the present exemplary embodiment is capable of preventing or at least reducing errors in recognizing processing instruction information.

In addition, the present exemplary embodiment can appropriately notify the user of the necessary operation by displaying a notification message that prompts the user to instruct whether to output the read document image as a monochromatic copy. Accordingly, the present exemplary embodiment can prevent or at least reducing an error by the user in instructing and executing the processing. It is not necessary to execute the entire processing in the flow chart described above. In other words, it is also useful if a part of the above-described processing only is executed.

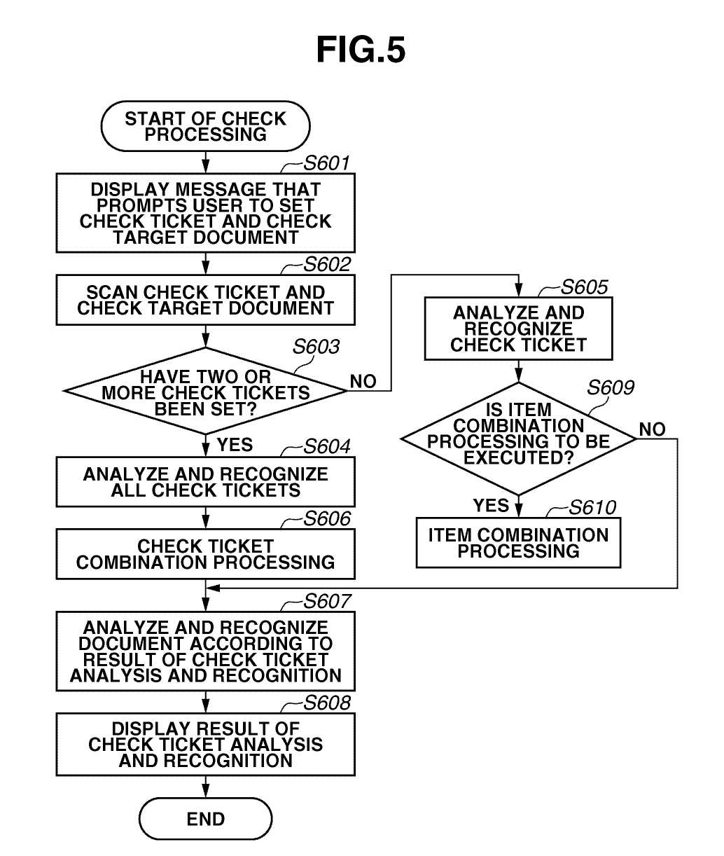

Now, a method for executing checking in step S524 instructed for the processing target document according to the extracted processing instruction information by using the scan ticket generated in the above-described manner will be described in detail below with reference to FIG. 5.

FIG. 5 is a flow chart illustrating an exemplary flow of processing for executing checking on the check target document, which is the processing target document by using the scan ticket. The processing in the flow chart of FIG. 5 is implemented by the CPU 11 by loading and executing a program from the ROM 19 on the RAM 18. The processing illustrated in FIG. 5 is executed if the user has instructed the generation of a scan ticket in step S521 in FIG. 3.

When the user instructs checking of the check target document via the operation unit 16, the processing illustrated in FIG. 5 starts. Referring to FIG. 5, in step S601, the CPU 11 displays a message, on the operation unit 16, which prompts the user to set the scan ticket printed in step S522 in FIG. 3B and the check target document on the document feeder in this order.

After setting the scan ticket and the check target document on the document feeder, if the user has instructed reading of the document by pressing the OK button of the operation unit 16, then the processing proceeds to step S602. In step S602, the CPU 11 executes control for serially feeding the documents set on the document feeder, and starts processing for reading the document by using the scanner 15.

More specifically, the CPU 11 feeds the scan ticket, which has been set as the first sheet of the documents set on the document feeder, and reads the scan ticket by using the scanner 15. Furthermore, in step S602, the CPU 11 executes control for reading the check target document set on the scan ticket.

In the present exemplary embodiment, a plurality of check target documents can be set on the document feeder at the same time. In addition, by instructing via the operation unit 16 that the plurality of documents set on the document feeder are the documents for the same job, a number of documents for the same job divided into a plurality of document bundles can be set on the document feeder.

If the three scan tickets (FIGS. 4A through 4C) generated based on the processing instruction sheets (FIGS. 2B through 2D) are individually used (No in step S603), then the processing proceeds to step S605 because one scan ticket is to be used. If two or more scan tickets are to be used (Yes in step S603), then the processing proceeds to steps S604 and S606.

In step S605, the CPU 11 executes analysis and recognition on an image of the first document (the scan ticket) read in step S602. More specifically, the CPU 11 analyzes the two-dimensional code included in the read scan ticket. The CPU 11 recognizes the processing target field (the location of the field to be processed), which has been instructed to be processed, and the processing content based on the result of the analysis. In addition, the CPU 11 stores the result of the recognition on the RAM 18. The processing in steps S609 and S610 will be described in detail below in a third exemplary embodiment of the present invention.

Now, a case will be described where the three scan tickets (FIGS. 4A through 4C) generated based on the processing instruction sheet illustrated in FIGS. 2B through 2D are not individually used and all the three scan tickets (FIGS. 4A through 4C) are scanned together with the check target document.

The processing in steps S601 and S602 is similar to the above-described processing. Accordingly, the detailed description thereof will not be repeated here. In step S603, because the number of the scan tickets to be used is three, it is determined that two or more scan tickets are to be used (YES in step S603). In this case, the processing proceeds to step S604. In step S604, the CPU 11 executes analysis and recognition on the images of the three scan tickets (FIGS. 4A through 4C) read in step S602.

More specifically, the CPU 11 analyzes the two-dimensional code included in the plurality of read scan tickets. The CPU 11 recognizes the processing target field (the location of the field to be processed), which has been instructed to be processed, and the processing content based on the result of the analysis. In addition, the CPU 11 stores the result of the recognition on the RAM 18.

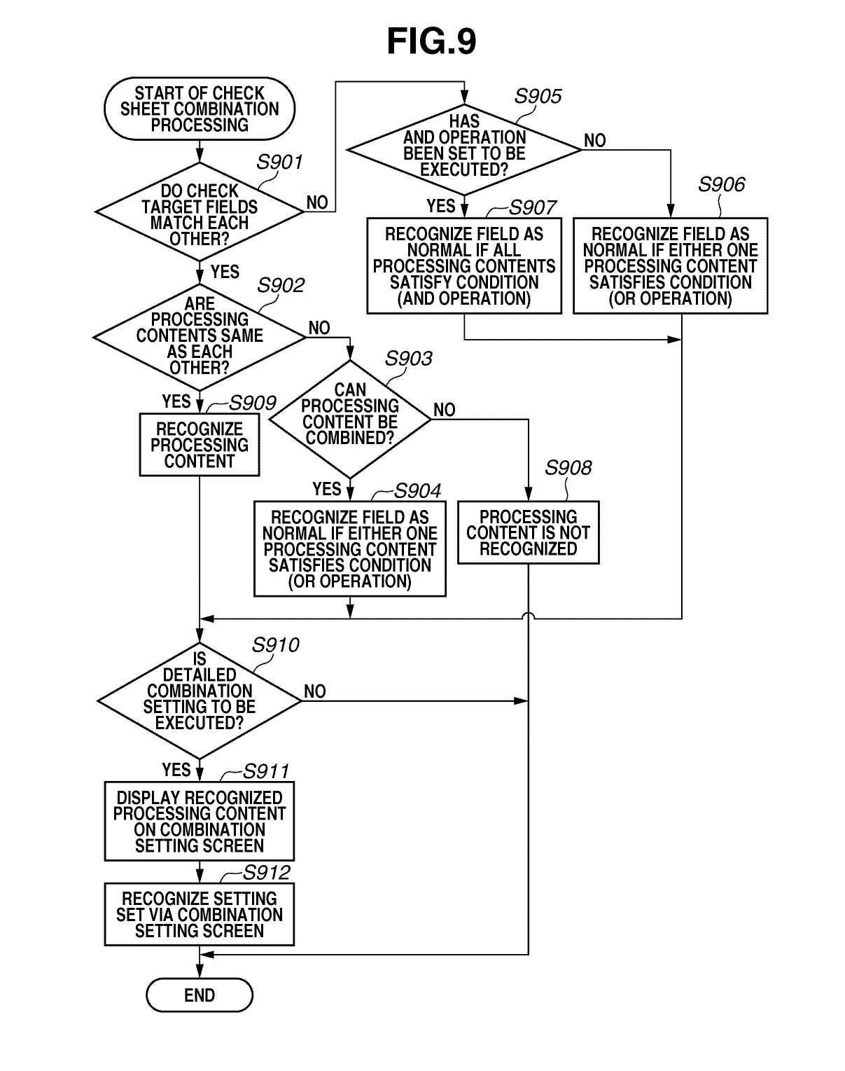

Now, processing for combining the scan tickets, which is executed in step S606, will be described in detail below. FIG. 9 is a flow chart illustrating an example of processing for combining the scan tickets. The CPU 11 executes processing for combining the recognized processing contents according to rules previously set and stored on the HDD 13.

If different processing contents have been recognized for the same processing target field, the CPU 11 recognizes that analysis and recognition, in which the check target document is determined to have been normally created if any one of processing contents of all check target documents has been extracted (i.e., an OR operation), is to be executed. Furthermore, the CPU 11 stores the result of the recognition on the RAM 18.

More specifically, in the present exemplary embodiment, the field 25 (FIG. 2C) and the field 26 (FIG. 2D) are included in the same processing target field (Yes in step S901) and have mutually different processing contents (No in step S902). Accordingly, in this case, processings for checking of different registered seals can be combined together.

In this case, in step S903, it is determined that the processing contents can be combined together (Yes in step S903). Then, the processing proceeds to step S904. In step S904, the CPU 11 stores, on the RAM 18, the analysis and recognition for analyzing and recognizing whether either one of the two registered seals, i.e., the registered seal instructed in the field 25 and the registered seal instructed in the field 26, exists within the processing target field.

For the content of processing to be executed for different processing target fields, the present exemplary embodiment executes an “AND operation”, which includes analysis and recognition in which it is determined that the processing target document has been normally created if all the processing contents thereof have been extracted, and an “OR operation”, which includes analysis and recognition in which it is determined that the processing target document has been normally created if either one of the processing contents thereof has been extracted. In step S905, the CPU 11 determines whether an AND operation has been set to be executed. An instruction describing which of the “AND operation” and the “OR operation” is to be executed is previously set to the HDD 13.

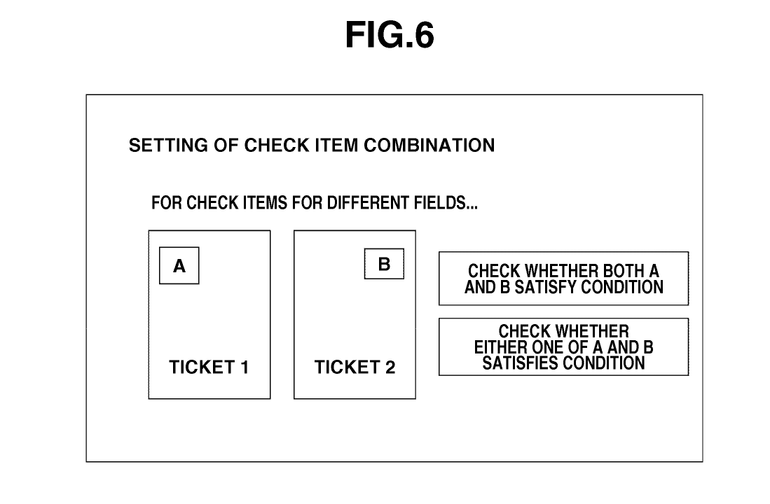

FIG. 6 illustrates an example of a screen displayed on the operation unit 16, which is used for setting which of the “AND operation” and the “OR operation” is to be executed. The setting can be executed during booting the image processing apparatus 100. Alternatively, the screen for executing the setting can be displayed on the operation unit 16 to allow the user to execute the setting every time a scan ticket is read.

Further alternatively, the setting can be performed from an external apparatus, which is connected to the image processing apparatus 100 via the network I/F 17. Suppose that for the content of the setting, it has been set to execute the “OR operation”, which includes analysis and recognition in which it is determined that the processing target document has been normally created if either one of the processing contents has been extracted.

In this case, the field 21 in FIG. 2B and the field 24 in FIG. 2C exist in mutually different processing target fields (No in step S901). Accordingly, the processing proceeds to step S906. In step S906, the CPU 11 stores, on the RAM 18, the analysis and recognition in which it is determined that the document has been normally created if either one of the two different processing contents (checking processings for checking different registered seals).

Suppose that it has been set that the “AND operation” is to be executed, which includes analysis and recognition in which the processing target document is determined to have been normally created if both of the two different processing contents (checking processings for checking different registered seals) have been extracted.

In this case, in step S907, the CPU 11 stores, on the RAM 18, the analysis and recognition in which the processing target document is determined to have been normally created if both of the two different processing contents (checking processings for checking different registered seals) have been extracted.

If the processing contents cannot be combined together for the same processing target field, the CPU 11 does not combine the processing contents.

In the present exemplary embodiment, the field 22 in FIG. 2B and the field 23 in FIG. 2C are included in the same processing target field. However, the processing to be executed for the field 22 in FIG. 2B is executed if the field 22 includes a text string while the processing to be executed for the field 23 in FIG. 2C is executed if the field 23 includes no description (i.e., if the field 23 has been left blank). Accordingly, it is determined that the content of the two processings are different from each other (No in step S903). Then, the processing proceeds to step S908. In step S908, the CPU 11 determines that any of the processing contents is not to be recognized or stored.

In step S909, if the same processing target field includes the same processing content, then the CPU 11 stores the corresponding analysis and recognition on the RAM 18.

After scanning all the scan tickets illustrated in FIGS. 4A through 4C and executing the processing for combining the scan tickets, the CPU 11 executes analysis and recognition for analyzing and recognizing whether either one of the two registered seals, i.e., the registered seal instructed in the field 25 and the registered seal instructed in the field 26, exists within the field including the field 25 (FIG. 2C) of the processing target document, which is included in the same field as the field the field 26 in FIG. 2D is included in.

For the field including the field 21 in FIG. 2B and the field 24 in FIG. 2C, the CPU 11 stores, on the RAM 18, an instruction for executing analysis and recognition for analyzing and recognizing whether either one of the two mutually different registered seals is included in the field.

In step S607, the CPU 11 analyzes and recognizes the check target document based on the result of the recognition that has been stored on the RAM 18. More specifically, if one scan ticket illustrated in FIG. 4A is to be used, the CPU 11 recognizes that the document has been normally created if the field 21 includes the corresponding registered seal and the field 22 includes a description.

If three scan tickets illustrated in FIGS. 4A through 4C are used and if the scan ticket has been combined, the CPU 11 recognizes that the document has been normally created if the field 25 in FIG. 2C (or the field 26 in FIG. 2D) includes either one of the registered seals instructed in the field 25 or 26.

Furthermore, for the field 21 in FIG. 2B and the field 24 in FIG. 2C, the CPU 11 determines that the document has been normally created if either one of the two mutually different registered seals is included in the field.

For the above-described recognition, the CPU 11 binarizes the image included in the field 22 by using a predetermined threshold value. Furthermore, if the ratio of black pixels to all the pixels included in the image is 20% or higher (i.e., if the area of the image to the entire field 22 is 20% or higher), then the CPU 11 recognizes that the field 22 includes a description. The numerical value of the above-described ratio is a mere example. Accordingly, a numerical value other than 20% can be used. Furthermore, a recognition method other than that described above can be used instead.

In addition, the CPU 11 serially stores a page number of the check target document and the recognition result for the page on the RAM 18. If all the recognition results are positive (normal) for one check target document, the CPU 11 determines that the check target document has been normally created. On the other hand, if at least one recognition result is negative, then the CPU 11 determines that the check target document has not been normally created.

After completely recognizing all the check target documents, the CPU 11 accumulates the recognition results of all the check target documents stored on the RAM 18. In the present exemplary embodiment, the accumulation of the recognition results includes calculation and accumulation of the total number of check target documents whose checking has been completed, the number of fields whose recognition result is negative, and the page number of the page of the document including the field whose determination result is negative.

For the page number, the CPU 11 sets the first sheet of the check target document except the scan ticket as the first page, in order of reading the documents by using the scanner 15 (i.e., in order of feeding the documents from the document feeder). Any information other than that described above can be further accumulated by the CPU 11 if any information stored on the RAM 18 that can be identified exists.

In the present exemplary embodiment, the results are stored on the RAM 18 as described above. However, the same effect as the effect of the above-described exemplary embodiment can be implemented by storing the results on the HDD 13. In step S608, the CPU 11 executes control for displaying the result of the accumulation in step S607 on the operation unit 16.

With the above-described configuration, the present exemplary embodiment can determine a new processing content based on a combination of a plurality of processings or on selected specific processing only according to information extracted from a plurality of processing instruction sheets read by the scanner.

Now, a second exemplary embodiment of the present invention will be described in detail below. In the present exemplary embodiment, it is enabled for the user to execute a more detailed setting for the scan ticket combination processing in step S606 than the first exemplary embodiment described above.

The processing in steps S601 through S604, which includes the processing for setting the scan ticket and the check target document set on the scan ticket on the document feeder up to the scan ticket analysis and recognition, is the same as that in the first exemplary embodiment described above. Accordingly, the detailed description thereof will not be repeated here.

FIG. 9 is a flow chart illustrating an exemplary flow of processing for combining a plurality of scan tickets.

In the processing for combining the scan tickets in step S606, in the above-described first exemplary embodiment, the CPU 11 executes the analysis and recognition for analyzing and recognizing whether either one of the registered seals instructed in the field 25 or 26 is included in the field 25 in FIG. 2C or the field 26 in FIG. 2D. In addition, in the above-described first exemplary embodiment, the CPU 11 stores, on the RAM 18, an instruction instructing that the analysis and recognition for analyzing and determining whether either one of the two mutually different registered seals is included in the field 21 in FIG. 2B or the field 24 in FIG. 2C is to be executed.

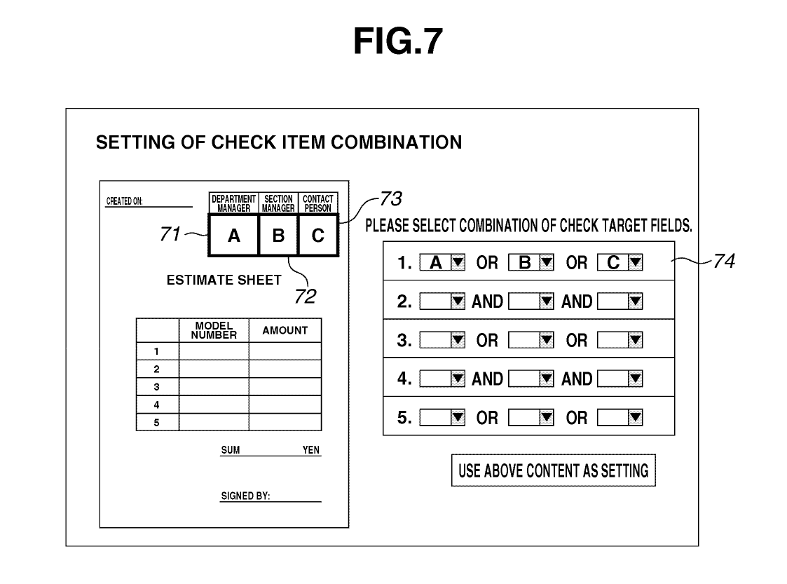

In the present exemplary embodiment, the contents of the analysis and recognition are combined in detail in step S910. FIG. 7 illustrates an example of a screen displayed on the operation unit 16 during processing for setting the combination of the processing contents according to the present exemplary embodiment, which is displayed in step S911. The content of the processing executed for the field 21 in FIG. 2B is indicated as a processing content “A”, which is included in a field 71 illustrated in FIG. 7. Similarly, the content of the processing executed for the field 24 in FIG. 2C is indicated as a processing content “B”, which is included in a field 72 illustrated in FIG. 7. Furthermore, the content of the processing executed for the field 25 in FIG. 2C, which is included in the same field as the field including the field 26 (FIG. 2D), is indicated as a processing content “C”, which is included in a field 73 illustrated in FIG. 7.

In performing a setting for instructing the execution of an “OR operation”, which includes analysis and recognition for analyzing and recognizing whether either one of the three processing contents A through C is included in each corresponding field, is to be executed, the user selects the processing content A, B, or C as illustrated in the field 74. Furthermore, the CPU 11 stores an instruction for executing the above-described analysis and recognition on the RAM 18.

On the other hand, in performing a setting for executing an AND operation, which includes analysis and recognition for analyzing and recognizing whether all the three processing contents A through C are included in each corresponding field, is to be executed, the user selects “A and B and C”. In step S912, the CPU 11 stores an instruction for executing the above-described analysis and recognition.

In the present exemplary embodiment, in step S607 and subsequent steps, the CPU 11 executes the analysis and recognition on the check target document according to the result of the recognition stored on the RAM 18 similarly to the first exemplary embodiment described above. Accordingly, the detailed description thereof will not be repeated here.

With the above-described configuration, the present exemplary embodiment can determine a new processing content based on a combination of a plurality of processings or on selected specific processing according to information extracted from a plurality of processing instruction sheets read by the scanner. In addition, according to the present exemplary embodiment having the above-described configuration, the user is enabled to execute a detailed setting of combined processing for a processing target field.

Now, a third exemplary embodiment of the present invention will be described in detail below. In the present exemplary embodiment, in the processing for combining the processing items executed in step S609, candidates of combination are automatically displayed on the operation unit 16 so that the user can execute a detailed setting for the combination.

In the present exemplary embodiment, the CPU 11 executes the same processing for setting the scan ticket and the check target document on the scan ticket on the document feeder as that in the first exemplary embodiment. Accordingly, the detailed description thereof will not be repeated here.

In step S602, the CPU 11 executes control for scanning the scan ticket illustrated in FIG. 4B, which has been generated based on the processing instruction sheet illustrated in FIG. 2C, together with the check target document. After that, the CPU 11 executes the processing up to the processing in step S605 similar to that described above in the first exemplary embodiment. Accordingly, the detailed description thereof will not be repeated here.

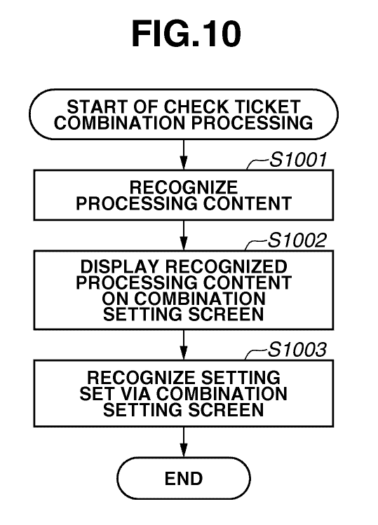

FIG. 10 is a flow chart illustrating an example of processing for combining the processing items recognized from the scan ticket according to a user instruction.

Referring to FIG. 10, if it is determined that the processing items are to be combined together (YES in step S609), then the processing proceeds to step S610. In step S610, the CPU 11 combines the processing items. By executing the analysis and recognition on the scan ticket illustrated in FIG. 4B, three processing items for analyzing and recognizing whether the field 24 in FIG. 2C includes a corresponding seal, whether the field 25 includes a corresponding seal, and whether the field 23 includes no description (i.e., whether the field 23 has been left blank) are recognized in step S1001 in FIG. 10.

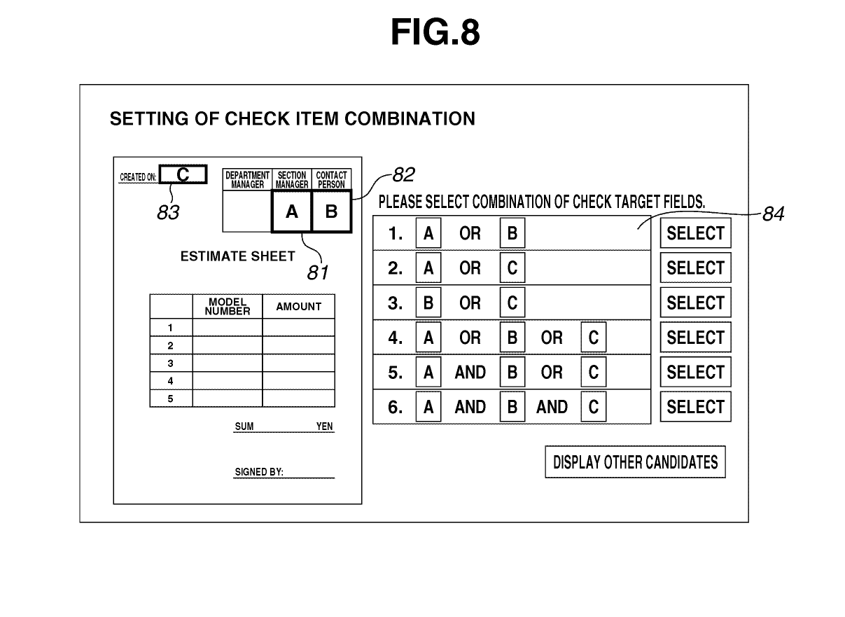

FIG. 8 illustrates an example of a screen displayed on the operation unit 16 for executing a setting for combining the processing items. The content of the processing executed for the field 24 in FIG. 2C is indicated as a processing content “A”, which is included in a field 81 illustrated in FIG. 8. Similarly, the content of the processing executed for the field 25 in FIG. 2C is indicated as a processing content “B”, which is included in a field 82 illustrated in FIG. 8. Furthermore, the content of the processing executed for the field 23 in FIG. 2C is indicated as a processing content “C”, which is included in a field 83 illustrated in FIG. 8.

In step S1002, the CPU 11 displays candidates of combination of the three processing contents “A” through “C” in a field 84. In step S1003, the CPU 11 stores a processing content selected from among the candidates of the combination displayed in the field 84 on the RAM 18.

In the present exemplary embodiment, in step S607 and the subsequent steps, the CPU 11 executes the analysis and recognition on the check target document according to the result of the recognition stored on the RAM 18 similarly to the first exemplary embodiment described above. Accordingly, the detailed description thereof will not be repeated here.

With the above-described configuration, the present exemplary embodiment can allow the user to perform a detailed setting for combining the processing items by selecting one from the candidates of combination automatically displayed on the operation unit 16 based on the information extracted from one processing instruction sheet read by using the scanner.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-295440 filed Dec. 25, 2009, which is hereby incorporated by reference herein in its entirety.

What is claimed is:

1. An information processing apparatus configured to extract information about a processing target field from a processing instruction sheet, which is a document including a description of a processing target field of a processing target document, read a ticket to which an image that has been encoded into a format that enables recognition of a content of processing to be executed for the processing target field is added, and execute processing extracted from the information added to the ticket, the information processing apparatus comprising:
a reading unit configured to read a plurality of tickets;
a recognition unit configured to recognize a processing target field and a content of processing to be executed for the field from the ticket read by the reading unit; and
a determination unit configured to determine a content of processing to be executed for the processing target field according to a combination of a plurality of processing contents recognized by the recognition unit for the processing target field recognized by the recognition unit,
wherein processing having the content determined by the determination unit is executed on the processing target document.

2. The information processing apparatus according to claim 1, wherein the determination unit is configured to automatically combine the processing contents recognized by the recognition unit.

3. The information processing apparatus according to claim 1, wherein the determination unit is configured to combine the processing contents according to an instruction given by a user.

4. The information processing apparatus according to claim 1, wherein the determination unit is configured, if the processing target fields recognized by the recognition unit are the same as one another, to combine the processing contents so that the processing target field is determined to be normal if either one of a plurality of processing contents recognized by the recognition unit has been extracted.

5. The information processing apparatus according to claim 1, wherein if different processing target fields are to be subjected to recognition by the recognition unit, the determination unit is configured to combine the processing contents so that either one of a processing content for determining that the processing target field is normal if either one of the plurality of processing contents recognized by the recognition unit has been extracted and a processing content for determining that the processing target field is normal if all the plurality of processing contents recognized by the recognition unit have been extracted is to be processed according to a previously set setting.

6. The information processing apparatus according to claim 1, wherein if processing target fields recognized by the recognition unit are the same as one another and different processing contents have been recognized by the recognition unit, the determination unit is configured not to recognize the processing.

7. A method for controlling an information processing apparatus configured to extract information about a processing target field from a processing instruction sheet, which is a document including a description of a processing target field of a processing target document, read a ticket to which an image that has been encoded into a format that enables the extracted information and a content of processing to be executed for the processing target field is added, and execute processing for extracting the information added to the ticket, the method comprising:
reading a plurality of tickets;
recognizing a processing target field and a content of processing to be executed for the field from the read ticket;
determining a content of processing to be executed for the processing target field according to a combination of a plurality of recognized processing contents for the recognized processing target field; and
executing processing having the determined content on the processing target document.

8. The method according to claim 7, further comprising automatically combining the recognized processing contents.

9. The method according to claim 7, further comprising combining the processing contents according to an instruction given by a user.

10. The method according to claim 7, further comprising combining the processing contents, if the recognized processing target fields are the same as one another, so that the processing target field is determined to be normal if either one of a plurality of recognized processing contents has been extracted.

11. The method according to claim 7, further comprising combining the processing contents, if different processing target fields are to be recognized, so that either one of a processing content for determining that the processing target field is normal if either one of the plurality of recognized processing contents has been extracted and a processing content for determining that the processing target field is normal if all the plurality of recognized processing contents have been extracted is to be processed according to a previously set setting.

12. The method according to claim 7, further comprising, if recognized processing target fields are the same as one another and different processing contents have been recognized, not recognizing the processing.

13. A computer-readable storage medium storing instructions which, when executed by a computer, cause the computer to perform operations of the method according to claim 7.
